(19) United States
(12) Patent Application Publication
(10) Pub. No.: US 2024/0034300 A1
(43) Pub. Date: Feb. 1, 2024

(54) SYSTEMS AND METHODS FOR UTILIZING HYBRID TECHNOLOGIES TO MITIGATE AFTERTREATMENT SYSTEM DEGRADATION

(71) Applicant: Cummins Inc., Columbus, IN (US)

(72) Inventors: Lu Qiu, Columbus, IN (US); David Schmidt, Indianapolis, IN (US); Yuying Song, Columbus, IN (US); Jinyong Luo, Columbus, IN (US); Ying Yuan, Rexford, NY (US); Manik Narula, Columbus, IN (US)

(73) Assignee: Cummins Inc., Columbus, IN (US)

(21) Appl. No.: 18/266,201

(22) PCT Filed: Dec. 8, 2021
(86) PCT No.: PCT/US2021/062386

§ 371 Date: Jun. 8, 2023

Related U.S. Application Data
(60) Provisional application No. 63/199,143, filed on Dec. 9, 2020.

(51) Int. Cl. B60W 20/15; B60W 10/06

(52) U.S. Cl. CPC B60W 20/15; B60W 10/06; B60W 2510/068; B60W 2510/244

(57) ABSTRACT

A method includes determining, by a controller, that a transient event for a hybrid vehicle is occurring; determining, by the controller, an increase of power demand for the hybrid vehicle based on the determined transient event; directing, by the controller, an amount of power from an electric motor of the hybrid vehicle to a powertrain of the hybrid vehicle based on the increase in power demand, the amount of power from the electric motor determined based on at least one of a state of charge of a battery of the hybrid vehicle; and increasing, by the controller, an amount of power from an engine of the hybrid vehicle as a power output from the electric motor decays to avoid an engine power output spike from the engine based on the determined increase in power demand.

### CROSS-REFERENCE TO RELATED APPLICATION

This application claims the benefit of and priority to U.S. Provisional Application No. 63/199,143, filed Dec. 9, 2020, titled “SYSTEMS AND METHODS FOR UTILIZING HYBRID TECHNOLOGIES TO MITIGATE AFTERTREATMENT SYSTEM DEGRADATION,” which is incorporated herein by reference in its entirety.

### TECHNICAL FIELD

The present disclosure relates mitigating the degradation of components in an exhaust aftertreatment system and, particularly, the components of an exhaust aftertreatment system coupled to an electrified powertrain, such as in a hybrid vehicle.

### BACKGROUND

Exhaust aftertreatment systems are generally designed to reduce emissions of particulate matter, nitrogen oxides (NOx), hydrocarbons, and other environmentally harmful pollutants. However, the components that make up the exhaust aftertreatment system can be susceptible to failure and degradation. Because the failure or degradation of components may have adverse consequences on performance, such as the emission-reduction capability of the exhaust aftertreatment system, mitigation of component degradation is desirable.

### SUMMARY

One embodiment relates to a method. The method includes determining, by a controller, that a transient event for a hybrid vehicle is occurring; determining, by the controller, an increase of power demand for the hybrid vehicle based on the determined transient event; directing, by the controller, an amount of power from an electric motor of the hybrid vehicle to a powertrain of the hybrid vehicle based on the increase in power demand, the amount of power from the electric motor determined based on a state of charge of a battery of the hybrid vehicle; and increasing, by the controller, an amount of power from an engine of the hybrid vehicle as a power output from the electric motor decays to avoid an engine power output spike from the engine based on the determined increase in power demand.

In some of these embodiments, the increase of the amount of power from the engine is based on at least one of the state of charge of the battery; a spin rate of a turbine of a turbocharger of the hybrid vehicle, and an expected timing value from a map of transient responses. In other of these embodiments, the method further includes engaging, by the controller, normal hybrid operation for the hybrid vehicle. Engaging normal hybrid operation may be based on a determination that the spin rate of the turbine of the turbocharger is at an operational threshold and/or that an air/fuel ratio of the engine is at an acceptable threshold.

Another embodiment relates to a method for managing a temperature of an aftertreatment system in a hybrid vehicle. The method includes determining, by a controller, the temperature of the aftertreatment system; comparing, by the controller, the temperature of the aftertreatment system to a threshold; and responsive to the comparison, causing, by the controller, a thermal management action for the aftertreatment system, the thermal management action including at least one of directing, by the controller, an engine of the hybrid vehicle to operate at a relatively higher load than a present engine load; or bypassing a turn off event for the engine so the engine runs during a vehicle stop period.

In some of these embodiments, the thermal management action further includes reducing, by the controller, an amount of energy from an electric motor of the hybrid vehicle to a powertrain of the hybrid vehicle. In other of these embodiments, in response to the temperature of the aftertreatment system being at or above the threshold, the thermal management action comprises at least one of engaging, by the controller, an electric vehicle mode for the hybrid vehicle such that power for the hybrid vehicle is solely provided by the engine; and directing, by the controller, a first amount of power from an electric motor of the hybrid vehicle and a second amount of power from an engine of the hybrid vehicle to a powertrain of the hybrid vehicle, wherein the first amount and the second amount are determined by the controller based an amount of engine-out NOx.

Yet another embodiment relates to a method for managing an amount of soot accumulation in an aftertreatment system of a hybrid vehicle. The method includes determining, by a controller, that an exhaust gas temperature is below a threshold temperature of a passive regeneration event; and responsive to the determination, performing, by the controller, at least one of directing, by the controller, an engine of the hybrid vehicle to operate at a higher load by charging a generator or battery of the hybrid vehicle; directing, by the controller, the engine to continue running during a vehicle stop period; or activating, by the controller, a heater in the aftertreatment system.

In some of these embodiments, the heater is positioned upstream of a Diesel Oxidation Catalyst (DOC) and/or upstream of a Selective Catalytic Reduction (SCR) system.

Yet another embodiment relates to method for managing a hybrid vehicle during idle operation. The method includes determining, by a controller, a temperature of an aftertreatment system of the hybrid vehicle; determining, by the controller, at least one of an amount of hydrocarbon or water accumulation in the aftertreatment system, the amount of accumulation based on the temperature of the aftertreatment system; responsive to the amount of accumulation exceeding a predefined amount, performing, by the controller, at least one of directing, by the controller, an engine of the hybrid vehicle to operate at a higher load by charging a generator or battery of the hybrid vehicle; or activating, by the controller, a heater in the aftertreatment system.

In some of these embodiments, the temperature of the aftertreatment system is a steady-state temperature, and the method further includes determining, by the controller, that the steady-state temperature is less than a condensation temperature threshold; responsive to the determination that the steady-state temperature is less than the condensation temperature threshold, directing, by the controller, the engine of the hybrid vehicle to operate at the higher load; determining, by the controller, a temperature of the aftertreatment system following the operation of the engine at the higher load; and responsive to a determination that the temperature of the aftertreatment system following the operation of the engine at the higher load is less than the condensation temperature threshold, activating, by the controller, the heater in the aftertreatment system.

Yet another embodiment relates to a system. The system includes a controller for a hybrid vehicle. The controller includes a processing circuit including at least one processor coupled to at least one memory storing instructions that, when executed by the at least one processor, cause the controller to: determine that a transient event for the hybrid vehicle is occurring; determine an increase of power demand for the hybrid vehicle based on the determined transient event; direct an amount of power from an electric motor of the hybrid vehicle to a powertrain of the hybrid vehicle based on the increase in power demand, the amount of power from the electric motor determined based on a state of charge of a battery of the hybrid vehicle; and increase an amount of power from an engine of the hybrid vehicle as a power output from the electric motor decays.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements. In this regard, numerous specific details are provided to impart a thorough understanding of embodiments of the subject matter of the present disclosure. The described features of the subject matter of the present disclosure may be combined in any suitable manner in one or more embodiments and/or implementations. One or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE FIGURES

FIG. 1 is a schematic diagram of a system with a controller, as shown in an exemplary embodiment.

FIG. 2 is a schematic diagram of the controller of the system of FIG. 1, according to an exemplary embodiment.

FIG. 3A is a set of plots showing engine torque and engine-out soot over time, according to an exemplary embodiment.

FIG. 3B is a set of plots showing system torque and engine-out soot over time, according to an exemplary embodiment.

FIG. 4 is a flow diagram of a method for the system of FIG. 1 in transient operation, according to an exemplary embodiment.

FIG. 5A is a table showing the effects on the system of various procedures for managing a temperature of the aftertreatment system, according to an exemplary embodiment.

FIG. 5B is a table showing the effects on the system of various procedures for managing a temperature of the aftertreatment system, according to an exemplary embodiment.

FIG. 6 is a flow diagram of a method for managing a temperature of the aftertreatment system, according to an exemplary embodiment.

FIG. 7 is a table showing the effects on the system of various procedures for affecting aftertreatment system regeneration, according to an exemplary embodiment.

FIG. 8A is a flow diagram of a method for reducing the accumulation of hydrocarbon and water in the aftertreatment system during idle operation, according to an exemplary embodiment.

FIG. 8B is a flow diagram of a method for reducing the accumulation of hydrocarbon and water in the aftertreatment system during idle operation, according to an exemplary embodiment.

### DETAILED DESCRIPTION

Following below are more detailed descriptions of various concepts related to, and implementations of, methods, apparatuses, and systems for mitigating the degradation of components in an aftertreatment system. Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring to the Figures generally, the various embodiments disclosed herein relate to systems, apparatuses, and methods for mitigating the degradation of components in an exhaust aftertreatment system. Exhaust aftertreatment system components may include a diesel oxidation catalyst (DOC), a diesel particulate filter (DPF), a selective catalytic reduction (SCR) system, and among potentially other components, an ammonia slip (ASC) catalyst. As these components treat exhaust gas from an engine, hydrocarbons (HC) and particulate matter (PM) in the exhaust (such as soot) may build up on various components, which can affect the effectiveness of the components. For example, the active site areas on catalysts (i.e., the portions of the catalyst that cause a reduction reaction in the exhaust gas) may be reduced and/or the flow of exhaust through the system may be obstructed. Generally, when these build-ups reach an unacceptable level, a regeneration event is initiated in order to burn off the deposits from the components. While these regeneration events do restore the aftertreatment system component's performance in the short-term, the elevated heat levels of regeneration events can have long-term degradation effects on the components of the aftertreatment system. The systems, apparatuses, and methods of the present disclosure are operable to reduce the frequency of regeneration events while maintaining short-term performance of the aftertreatment system and avoiding long-term degradation effects from both hydrothermal and chemical aging perspectives.

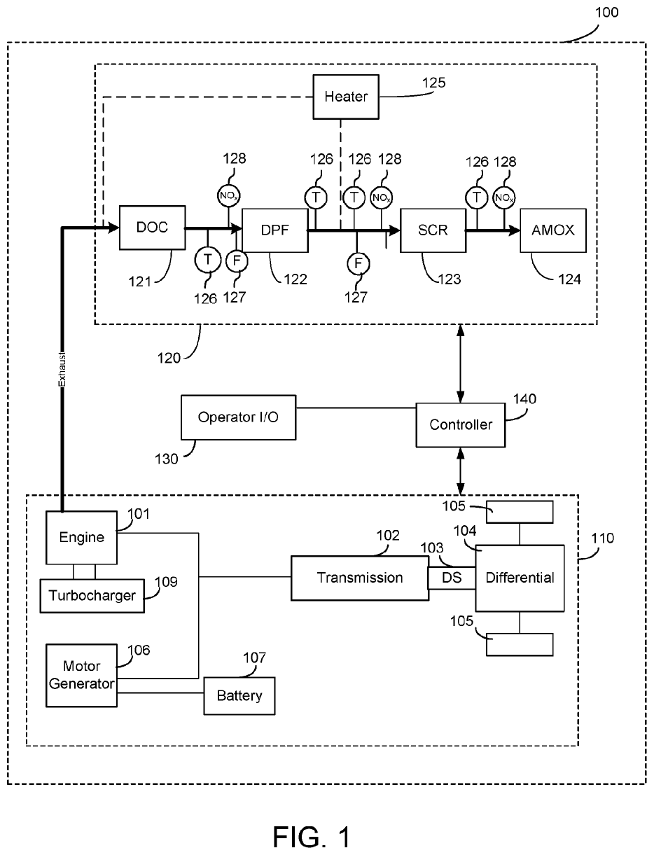

Referring now to FIG. 1, a vehicle 100 is shown, according to an example embodiment. The vehicle 100 includes a powertrain system 110, an aftertreatment system 120, an operator input/output (I/O) device 130, and a controller 140, where the controller 140 is communicably coupled to each of the aforementioned components. In the configuration of FIG. 1, the vehicle 100 is a hybrid vehicle. The hybrid vehicle 100 may be series hybrid, such that the engine 101 provides power to a motor/generator 106, which provides power to the battery 107 and/or to the transmission 102. The hybrid vehicle 100 may also be a parallel configuration vehicle. For example, in a parallel configuration both the electric motor and the internal combustion engine are operably connected to the drivetrain/transmission to propel the vehicle simultaneously. In contrast, in a series-parallel configuration, the engine and the electric motor can provide power independently or simultaneously.

The powertrain system 110 facilitates power transfer from the engine 101 and/or motor generator 106 to propel the vehicle 100. The powertrain system 110 includes the engine 101 and the motor generator 106 operably coupled to a transmission 102. The powertrain system may further include a clutch or a torque converter configured to transfer the rotating power from the engine 101 and/or the motor generator 106 to the transmission 102. In some embodiments, the clutch is located between the engine 101 and the motor generator 106. The transmission 102 is operatively coupled to a drive shaft 103, which is operatively coupled to a differential 104, where the differential 104 transfers power output from the engine 101 and/or motor generator 106 to the final drive (shown as wheels 105) to propel the vehicle 100. As a hybrid vehicle, the powertrain system 110 is structured as an electrified powertrain.

As a brief overview, the engine 101 receives a chemical energy input (e.g., a fuel such as gasoline or diesel) and combusts the fuel to generate mechanical energy, in the form of a rotating crankshaft. In comparison, the motor generator 106 may also be in a power receiving relationship with an energy source, such as the battery 107 that provides an input energy to output usable work or energy to in some instances propel the vehicle 100 alone or in combination with the engine 101. In this configuration, the hybrid vehicle has a parallel drive configuration. However, it should be understood, that other configurations of the vehicle 100 are intended to fall within the spirit and scope of the present disclosure (e.g., a series configuration and non-hybrid applications etc.). As a result of the power output from at least one of the engine 101 and the motor generator 106, the transmission 102 may manipulate the speed of the rotating input shaft (e.g., the crankshaft) to effect a desired drive shaft 103 speed. The rotating drive shaft 103 is received by a differential 104, which provides the rotation energy of the drive shaft 103 to the final drive 105. The final drive 105 then propels or moves the vehicle 100.

The engine 101 is an internal combustion engine (e.g., compression-ignition or spark-ignition), such that it can be powered by any fuel type (e.g., diesel, ethanol, gasoline, etc.). The engine 101 includes one or more cylinders and associated pistons. In the example shown, the engine 101 is a diesel powered compression-ignition engine. Air from the atmosphere is combined with fuel, and combusted, to produce power for the vehicle. Combustion of the fuel and air in the compression chambers of the engine 101 produces exhaust gas that is operatively vented to an exhaust pipe and to the exhaust aftertreatment system. The engine 101 may be coupled to a turbocharger 109. The turbocharger 109 includes a compressor coupled to an exhaust gas turbine via a connector shaft. Generally, hot exhaust gasses spin the turbine which rotates the shaft and in turn, the compressor, which draws air in. By compressing the air, more air can enter the cylinders, or combustion chamber, thus burning more fuel and increasing power and efficiency. A heat exchanger, such as a charge air cooler, may be used to cool the compressed air before the air enters the cylinders. In some embodiments, the turbocharger 109 is omitted.

Although referred to as a “motor generator” 106 herein, thus implying its ability to operate as both a motor and a generator, it is contemplated that the motor generator component, in some embodiments, may be an electric generator separate from the electric motor (i.e., two separate components) or just an electric motor. Further, the number of electric motors or motor generators may vary in different configurations. The principles and features described herein are also applicable to these other configurations. Among other features, the motor generator 106 may include a torque assist feature, a regenerative braking energy capture ability, and a power generation ability (i.e., the generator aspect). In this regard, the motor generator 106 may generate a power output and drive the transmission 102. The motor generator 106 may include power conditioning devices such as an inverter and motor controller, where the motor controller may be coupled to the controller 140. In other embodiments, the motor controller may be included with the controller 140.

The battery 107 may be configured as any type of rechargeable (i.e., primary) battery and of any size. In some embodiments, the battery 107 may be other electrical energy storing and providing devices, such as one or more capacitors (e.g., ultra-capacitors, etc.). In still other embodiments, the battery 107 may be a battery system that includes one or more rechargeable batteries and energy storing and providing devices (e.g., ultra-capacitors, etc.). The battery 107 may be one or more batteries typically used or that may be used in hybrid vehicles (e.g., Lithium-ion batteries, Nickel-Metal Hydride batteries, Lead-acid batteries, etc.). The battery 107 may be operatively and communicably coupled to the controller 140 to provide data indicative of one or more operating conditions or parameters of the battery 107. The data may include a temperature of the battery, a current into or out of the battery, a number of charge-discharge cycles, a battery voltage, etc. As such, the battery 107 may include one or more sensors coupled to the battery 107 that acquire such data. In this regard, the sensors may include, but are not limited to, voltage sensors, current sensors, temperature sensors, etc.

The aftertreatment system 120 is in exhaust-gas receiving communication with the engine 101. The aftertreatment system includes a diesel particulate filter (DPF) 122, a diesel oxidation catalyst (DOC) 121, a selective catalytic reduction (SCR) system 123, an ammonia oxidation catalyst (AMOX) 124, and a heater 125. The DOC 121 is structured to receive the exhaust gas from the engine 12 and to oxidize hydrocarbons and carbon monoxide in the exhaust gas, among its other functions such as NO oxidation to NO2 to promote passive DPF regeneration and fast SCR reaction. The DPF 122 is arranged or positioned downstream of the DOC 121 and structured to remove particulates, such as soot, from exhaust gas flowing in the exhaust gas stream. The DPF 122 includes an inlet, where the exhaust gas is received, and an outlet, where the exhaust gas exits after having particulate matter substantially filtered from the exhaust gas and/or converting the particulate matter into carbon dioxide. In some implementations, the DPF 122 may be omitted.

The aftertreatment system 120 may further include a reductant delivery system which may include a decomposition chamber (e.g., decomposition reactor, reactor pipe, decomposition tube, reactor tube, etc.) to convert a reductant into ammonia. The reductant may be, for example, urea, diesel exhaust fluid (DEF), Adblue®, a urea water solution (UWS), an aqueous urea solution (e.g., AUS32, etc.), and other similar fluids. A diesel exhaust fluid (DEF) is added to the exhaust gas stream to aid in the catalytic reduction. The reductant may be injected upstream of the SCR catalyst member by a DEF doser such that the SCR catalyst member receives a mixture of the reductant and exhaust gas. The reductant droplets then undergo the processes of evaporation, thermolysis, and hydrolysis to form gaseous ammonia within the decomposition chamber, the SCR catalyst member, and/or the exhaust gas conduit system, which leaves the aftertreatment system 120. The aftertreatment system 120 may further include an oxidation catalyst (e.g. the DOC 121) fluidly coupled to the exhaust gas conduit system to oxidize hydrocarbons and carbon monoxide in the exhaust gas. In order to properly assist in this reduction, the DOC 121 may be required to be at a certain operating temperature. In some embodiments, this certain operating temperature is approximately between 200-500° C. In other embodiments, the certain operating temperature is the temperature at which the HC conversion efficiency of the DOC 121 exceeds a predefined threshold (e.g. the conversion of HC to less harmful compounds, which is known as the HC conversion efficiency).

The SCR 123 is configured to assist in the reduction of NOx emissions by accelerating a NOx reduction process between the DEF and the NOx of the exhaust gas into diatomic nitrogen, water, and/or carbon dioxide. If the SCR catalyst member is not at or above a certain temperature, the acceleration of the NOx reduction process is limited and the SCR 123 may not be operating at a necessary level of efficiency to meet regulations. In some embodiments, this certain temperature is approximately 250-300° C. The SCR catalyst member may be made from a combination of an inactive material and an active catalyst, such that the inactive material, (e.g. ceramic metal) directs the exhaust gas towards the active catalyst, which is any sort of material suitable for catalytic reduction (e.g. base metals oxides like vanadium, molybdenum, tungsten, etc. or noble metals like platinum). In some embodiments, the AMOX 124 is included and structured to address ammonia slip by removing excess ammonia from the treated exhaust gas before the treated exhaust is released into the atmosphere.

Because the aftertreatment system 120 treats the exhaust gas before the exhaust gas is released into the atmosphere, some of the particulate matter or chemicals that are treated or removed from the exhaust gas may build up in the aftertreatment system over time. For example, the soot filtered out from the exhaust gas by the DPF 122 may build up on the DPF 122 over time. Similarly, sulfur particles present in fuel may accumulate in the SCR 123 and deteriorate the effectiveness of the SCR catalyst member. Further, DEF that undergoes incomplete thermolysis upstream of the catalyst may build up and form deposits on downstream components of the aftertreatment system 120. However, these build-ups on (and subsequent deterioration of effectiveness of) these components of the aftertreatment system 120 may be reversible. In other words, the soot, sulfur, and DEF deposits may be substantially removed from the DPF 122 and the SCR 123 by increasing a temperature of the exhaust gas running through the aftertreatment system to recover performance (e.g. for the SCR, conversion efficiency of NOx to N₂ and other compounds). These removal processes are referred to as regeneration events and may be performed for the DPF 122, SCR 123, or another component in the aftertreatment system 120 on which deposits develop. However, exposure to high temperatures during active regenerations degrades the DOC, DPF, and SCR catalysts. An active regeneration event is specifically commanded, such as a flow rate measurement through a DPF being below a predefined threshold indicating a partially blocked DPF which, in turn, causes the controller to command a regeneration event where exhaust gas temperatures are elevated in order to raise the temperature of the DPF and burn off the accumulated PM and other components (e.g., raise engine power output, post-injection, and other means to increase exhaust gas temperatures to cause a regeneration event). In contrast, a passive regeneration event occurs naturally during operation of the vehicle (e.g., a high load condition that may be experience while traversing a hill causes an increase in exhaust gas temperatures and regeneration event occurs naturally—not specifically commanded).

In some embodiments, the heater 125 is located in the exhaust flow path before the aftertreatment system 120 and is structured to controllably heat the exhaust gas upstream of the aftertreatment system 120. In some embodiments, the heater 125 is located directly before the DOC 121, while in other embodiments, the heater 125 is located directly before the SCR 123 or is located directly before the AMOX 124. The heater 125 may be any sort of external heat source that can be structured to increase the temperature of passing exhaust gas, which, in turn, increases the temperature of components in the aftertreatment system 120, such as the DOC 121 or the SCR 123. As such, the heater may be an electric heater, a grid heater, a heater within the SCR 123, an induction heater, a microwave, or a fuel-burning (e.g., HC fuel) heater. As shown here, the heater 125 is an electric heater that draws power from the battery 107. The heater 125 may be controlled by the controller 140 during an active regeneration event in order to heat the exhaust gas (e.g., by convection). Alternatively, the heater may be positioned proximate a desired component to heat the component (e.g., DPF) by conduction (and possibly convection). Multiple heaters may be used with the exhaust aftertreatment system, and each may be structured the same or differently (e.g., conduction, convection, etc.).

A grid heater may include an electrically conductive mesh structure configured to fit within the flow of the exhaust gas that allows the exhaust gas to flow through the mesh structure. The mesh structure can be, for example, a resistive heater that increases in temperature when coupled to an electric power source. The grid heater heats the gas, which in turn transfers heat to a catalyst of the aftertreatment system 120. As the exhaust gas flows through the grid heater, the temperature of the exhaust gas increases via convection.

A heater within the SCR 123 may include an electric heater embedded within, or otherwise coupled to, the catalyst substrate. The electric heater may be a resistive heater or any other type of suitable electric heater capable of heating the exhaust gas as it flows through the SCR 123.

An induction heater may include an electrically conductive structure configured to fit within the flow of the exhaust gas that allows the exhaust gas to flow through or around the structure. The structure is coupled to an electromagnet connected to a power source. The power source induces a high-frequency alternating current through the electromagnet, which generates current through the structure, causing the structure to heat up. As exhaust gas flows through the structure, the temperature of the exhaust gas increases via convection.

A microwave heater may include an electromagnetic radiation source in communication with the exhaust gas. The electromagnetic radiation source may rapidly vary electric and magnetic fields, causing the exhaust gas to increase in temperature.

Referring still to FIG. 1, an operator input/output (I/O) device 130 is also shown. The operator I/O device 130 may be communicably coupled to the controller 140, such that information may be exchanged between the controller 140 and the I/O device 130, wherein the information may relate to one or more components of FIG. 1 or determinations (described below) of the controller 140. The operator I/O device 130 enables an operator of the vehicle 100 to communicate with the controller 140 and one or more components of the vehicle 100 of FIG. 1. For example, the operator input/output device 130 may include, but is not limited to, an interactive display, a touchscreen device, one or more buttons and switches, voice command receivers, etc.

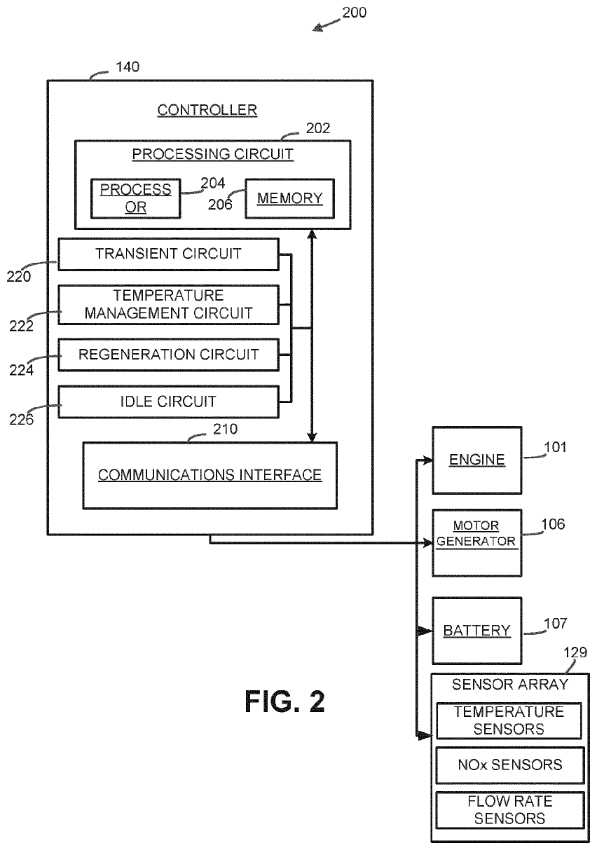

Briefly referencing FIG. 2, as also shown, a sensor array 129 is included in the aftertreatment system 120. The sensors are coupled to the controller 140, such that the controller 140 can monitor and acquire data indicative of operation of the vehicle 100. In this regard, the sensor array includes NOx sensors 128, flow rate sensors 127, and temperature sensors 126. The NOx sensors 128 acquire data indicative of or, if virtual, determine a NOx amount at or approximately at their disposed location. The flow rate sensors 127 acquire data indicative of or, if virtual, determine an approximate flow rate of the exhaust gas at or approximately at their disposed location. The temperature sensors 126 acquire data indicative of or, if virtual, determine an approximate temperature of the exhaust gas at or approximately at their disposed location. It should be understood that the depicted locations, numbers, and type of sensors is illustrative only. In other embodiments, the sensors may be positioned in other locations, there may be more or less sensors than shown, and/or different/additional sensors may also be included with the vehicle 100 (e.g., a pressure sensor, etc.). Those of ordinary skill in the art will appreciate and recognize the high configurability of the sensors in the vehicle 100.

The controller 140 is structured to control, at least partly, the operation of the vehicle 100 and associated sub-systems, such as the powertrain system 110, the turbocharger 109, and the operator input/output (I/O) device 130. Communication between and among the components may be via any number of wired or wireless connections. For example, a wired connection may include a serial cable, a fiber optic cable, a CAT5 cable, or any other form of wired connection. In comparison, a wireless connection may include the Internet, Wi-Fi, cellular, radio, etc. In one embodiment, a controller area network (CAN) bus provides the exchange of signals, information, and/or data. The CAN bus includes any number of wired and wireless connections. Because the controller 140 is communicably coupled to the systems and components of FIG. 1, the controller 140 is structured to receive data from one or more of the components shown in FIG. 1. The structure and function of the controller 140 is further described in regard to FIG. 2.

As the components of FIG. 1 are shown to be embodied in the vehicle 100, the controller 140 may be structured as one or more electronic control units (ECU). The function and structure of the controller 140 is described in greater detail in FIG. 2. The controller 140 may be separate from or included with at least one of a transmission control unit, an exhaust aftertreatment control unit, a powertrain control module, an engine control module, etc. In one embodiment, the components of the controller 140 are combined into a single unit. In another embodiment, one or more of the components may be geographically dispersed throughout the system. All such variations are intended to fall within the scope of the disclosure.

Referring now to FIG. 2, a schematic diagram of the controller 140 of the vehicle 100 of FIG. 1 is shown according to an example embodiment. As shown in FIG. 2, the controller 140 includes a processing circuit 202 having a processor 204 and a memory 206, a transient circuit 220, a temperature management circuit 222, a regeneration circuit 224, and an idle circuit 226, and a communications interface 210. The controller 140 is configured or structured to control the motor generator 106 in the hybrid powertrain system 110 to improve upon traditional methods of managing the aftertreatment system 120 in order to maintain short-term performance while avoiding long-term aftertreatment system component degradation.

In one configuration, the transient circuit 220, the temperature management circuit 222, the regeneration circuit 224, and the idle circuit 226 are embodied as machine or computer-readable media storing instructions that are executable by a processor, such as processor 204. As described herein and amongst other uses, the machine-readable media facilitates performance of certain operations to enable reception and transmission of data. For example, the machine-readable media may provide an instruction (e.g., command, etc.) to, e.g., acquire data. In this regard, the machine-readable media may include programmable logic that defines the frequency of acquisition of the data (or, transmission of the data). The computer readable media instructions may include code, which may be written in any programming language including, but not limited to, Java or the like and any conventional procedural programming languages, such as the “C” programming language or similar programming languages. The computer readable program code may be executed on one processor or multiple remote processors. In the latter scenario, the remote processors may be connected to each other through any type of network (e.g., CAN bus, etc.).

In another configuration, the transient circuit 220, the temperature management circuit 222, the regeneration circuit 224, and the idle circuit 226 are embodied as hardware units, such as electronic control units. As such, the transient circuit 220, the temperature management circuit 222, the regeneration circuit 224, and the idle circuit 226 may be embodied as one or more circuitry components including, but not limited to, processing circuitry, network interfaces, peripheral devices, input devices, output devices, sensors, etc. In some embodiments, the transient circuit 220, the temperature management circuit 222, the regeneration circuit 224, and the idle circuit 226 may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” In this regard, the transient circuit 220, the temperature management circuit 222, the regeneration circuit 224, and the idle circuit 226 may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on). The transient circuit 220, the temperature management circuit 222, the regeneration circuit 224, and the idle circuit 226 may also include programmable hardware devices such as field programmable gate arrays, programmable array logic, programmable logic devices or the like. The transient circuit 220, the temperature management circuit 222, the regeneration circuit 224, and the idle circuit 226 may include one or more memory devices for storing instructions that are executable by the processor(s) of the transient circuit 220, the temperature management circuit 222, the regeneration circuit 224, and the idle circuit 226. The one or more memory devices and processor(s) may have the same definition as provided below with respect to the memory 206 and processor 204. In some hardware unit configurations, the transient circuit 220, the temperature management circuit 222, the regeneration circuit 224, and the idle circuit 226 may be geographically dispersed throughout separate locations in the vehicle. Alternatively and as shown, the transient circuit 220, the temperature management circuit 222, the regeneration circuit 224, and the idle circuit 226 may be embodied in or within a single unit/housing, which is shown as the controller 140.

In the example shown, the controller 140 includes the processing circuit 202 having the processor 204 and the memory 206. The processing circuit 204 may be structured or configured to execute or implement the instructions, commands, and/or control processes described herein with respect to the transient circuit 220, the temperature management circuit 222, the regeneration circuit 224, and the idle circuit 226. The depicted configuration represents the transient circuit 220, the temperature management circuit 222, the regeneration circuit 224, and the idle circuit 226 as machine or computer-readable media storing instructions. However, as mentioned above, this illustration is not meant to be limiting as the present disclosure contemplates other embodiments where the transient circuit 220, the temperature management circuit 222, the regeneration circuit 224, and the idle circuit 226, or at least one circuit of the transient circuit 220, the temperature management circuit 222, the regeneration circuit 224, and the idle circuit 226, is configured as a hardware unit. All such combinations and variations are intended to fall within the scope of the present disclosure.

The processor 204 may be implemented as a single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A processor may be a microprocessor. A processor also may be implemented as a combination of computing devices, such as a combination of a DSP and a microprocessor, a plurality of microprocessors, one or more microprocessors in conjunction with a DSP core, or any other such configuration. In some embodiments, the one or more processors may be shared by multiple circuits (e.g., the transient circuit 220, the temperature management circuit 222, the regeneration circuit 224, and the idle circuit 226 may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure.

The memory 206 (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory 206 may be communicably connected to the processor 204 to provide computer code or instructions to the processor 204 for executing at least some of the processes described herein. Moreover, the memory 206 may be or include tangible, non-transient volatile memory or non-volatile memory. Accordingly, the memory 206 may include database components, object code components, script components, or any other type of information structure for supporting the various activities and information structures described herein.

The communications interface 210 may include any combination of wired and/or wireless interfaces (e.g., jacks, antennas, transmitters, receivers, transceivers, wire terminals) for conducting data communications with various systems, devices, or networks structured to enable in-vehicle communications (e.g., between and among the components of the vehicle) and out-of-vehicle communications (e.g., with a remote server). For example and regarding out-of-vehicle/system communications, the communications interface 210 may include an Ethernet card and port for sending and receiving data via an Ethernet-based communications network and/or a Wi-Fi transceiver for communicating via a wireless communications network. The communications interface 210 may be structured to communicate via local area networks or wide area networks (e.g., the Internet) and may use a variety of communications protocols (e.g., IP, LON, Bluetooth, ZigBee, radio, cellular, near field communication).

The communications interface 210 may facilitate communication between and among the controller 140 and one or more components of the vehicle 100 (e.g., the engine 101, the transmission 102, the aftertreatment system 120, the sensor array 129, etc.). Communication between and among the controller 140 and the components of the vehicle 100 may be via any number of wired or wireless connections (e.g., any standard under IEEE). For example, a wired connection may include a serial cable, a fiber optic cable, a CAT5 cable, or any other form of wired connection. In comparison, a wireless connection may include the Internet, Wi-Fi, cellular, Bluetooth, ZigBee, radio, etc. In one embodiment, a controller area network (CAN) bus provides the exchange of signals, information, and/or data. The CAN bus can include any number of wired and wireless connections that provide the exchange of signals, information, and/or data. The CAN bus may include a local area network (LAN), or a wide area network (WAN), or the connection may be made to an external computer (for example, through the Internet using an Internet Service Provider).

The transient circuit 220 is configured to command the motor generator 106 to assist a torque demand during transient operation in order to alleviate a transient load on the engine 101 thereby reducing the engine-out soot. During transient acceleration events, engine combustion generates high level soot/unburned hydrocarbons due to insufficient air flow and slow turbocharger 109 responses. However, high engine out soot increases the frequency of DPF active regeneration to remove the accumulated soot. Reducing engine-out soot reduces the frequency of DPF active regeneration, which in turn improves long-term performance from those components of the aftertreatment system 120 that are negatively affected by the exposure to high temperatures that occurs during active regeneration events. Transient operation (also referred to herein as a transient event) refers to a period of time in which a current power demand on the powertrain 110 is significantly different than a previous power demand. For example, an operator of the hybrid vehicle may depress the accelerator pedal as far or nearly as far as possible while passing another vehicle on a highway and then return to a previous steady-state vehicle speed. This passing moment is a transient event. As another example, when the hybrid vehicle travels uphill after previous substantially non-slope traversal of the hybrid vehicle, this uphill travel may be a transient event. While described above with respect to vehicle speed, the transient moment/event may also be defined with respect to engine speed or torque or operation of other vehicle components (e.g., a spike in exhaust aftertreatment system temperature, etc.). For example, in other embodiments, an aftertreatment sensor (e.g. a NOx) sensor may be used to determine a characteristic of the aftertreatment system (e.g., engine out NOx) and if that value exceeds a predefined threshold, a transient event is determined (e.g., an increase in engine out NOx amount exceeding a predefined threshold value relative to a current engine out NOx amount may indicate a transient moment). This examination has the benefit of examining when/if adverse emissions characteristics occur and determining a transient event in response to these adverse changes.

In one example, the controller 140 determines a transient moment of operation in the following way. If the current power demand differs from the previous power demand by more than a predefined amount or delta within a predefined period of time, the controller determines that a transient moment of operation is occurring. The power delta or difference may be approximated by engine speed, torque, or power. The predefined amount and predefined period of time may be variable value controllable by an operator and/or a manufacturer (e.g., a trim parameter).

Based on the controller 140 determining that the vehicle is in transient operation, the transient circuit 220 commands the motor generator 106 to provide an amount of power to the transmission 102 in order to supplement power provided by the engine 101 in order to fulfill the current power demand. Beneficially, this torque assist alleviates engine transient loads thereby reducing engine out soot and, in turn, the frequency of regeneration events (e.g., active DPF regeneration). In some embodiments, the transient circuit 220 commands the motor generator 106 to provide a certain (in one embodiment, a maximum) amount of available power, which is determined based on a state of charge (SOC) of the battery 107 or a thermal state of the motor generator 106 (i.e., whether the motor generator 106 is overheated). The transient circuit 220 then gradually increases the amount of power provided by the engine 101 in order to balance any loss in power from the motor generator 106 due to lower SOC and to allow the turbocharger 109 to begin swirling up (i.e., the turbine of the turbocharger 109 approaching an operational speed at which air is compressed). The transient circuit 220 enables this balance of power from the engine 101 and power from the motor generator 106 in order to also avoid a spike (i.e., relatively sudden increase) in power output from the engine based on the determined increase in power demand, which might cause a period of ‘rich’ engine operations, in order to maintain an acceptable air/fuel ratio. A “spike” may refer to an increase in power demand (e.g., horsepower) that exceeds a predefined value relative to the current power demand (e.g., an absolute amount such as 25 horsepower increase or a percentage value, such as twenty percent). In another example, the “spike” may change as a function of the current power output. In this regard, at relative low power outputs, the “spike” may be a relatively lower increase in power amount (e.g., 5 horsepower) whereas at higher power outputs, the spike may be a different value (e.g., 5+X horsepower). Thus, and in some embodiments, the “spike” value may not be constant at all power outputs. In other embodiments, the spike value is constant. To determine power output, sensors (virtual or real) may be used to determine speed and torque. As the power output capabilities of vehicles may vary, the “spike” for one vehicle may differ relative to another vehicle.

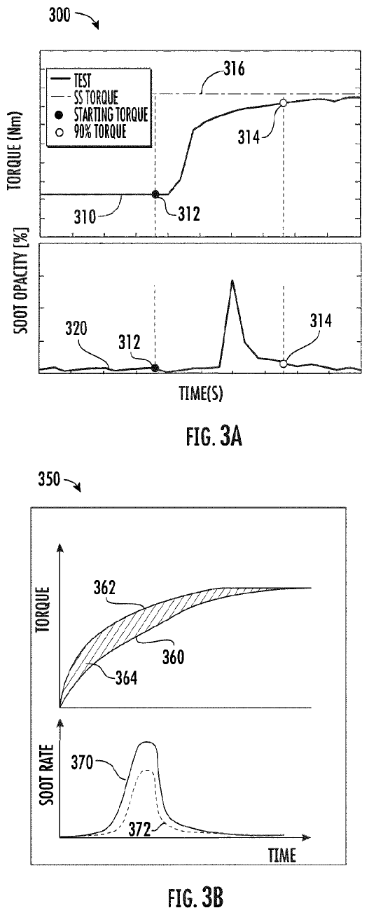

FIG. 3A is a set of plots showing engine torque and engine-out soot over time, according to an example embodiment. As shown in plot 300, there is a spike in soot opacity (i.e., a measurement for a quantity of soot present in the aftertreatment system 130) that aligns with a ramp-up in torque. Plot 300 has time in seconds as a shared x-axis and torque in Newton-meters (Nm) as a first y-axis and soot opacity in percentage as a second y-axis. The data on plot 300 is from an internal combustion engine (e.g., engine 101) operating without assistance from an electric motor (e.g., motor generator 106). Line 310 shows a value of engine torque over time. Point 312 marks a point in time at which the torque value is at a starting value (e.g., near zero). Point 314 marks a point in time at which the torque value is at 90% of a steady-state (i.e., operating) torque. Line 316 shows the steady-state torque target value for which the engine is aiming. Line 320 shows a value of soot opacity over time. As shown in plot 300, the value of the soot opacity spikes fairly drastically midway between points 312 and 314, which corresponds to a period shown in line 310 immediately after the torque ramps up quickly. When the torque is low but ramps up quickly (i.e., a transient moment), engine 101 combustion generates a high level of soot and unburned HC due to insufficient air flow and slow turbocharger 109 response at the low torque levels.

FIG. 3B is a set of plots showing system torque and engine-out soot over time, according to an example embodiment in which power is provided to the powertrain by the engine 101 and motor generator 106 (i.e., parallel hybrid). As shown in FIG. 3B, when the engine 101 and motor generator 106 provide power to the powertrain together (as opposed to the engine 101 by itself), the associated rate of soot accumulation is lessened. Plot 350 has time in seconds as a shared x-axis and torque as a first y-axis and soot rate as a second y-axis. Line 360 shows an engine torque for a system (such as a system including transient circuit 220) that utilizes power from both an internal combustion engine (e.g., engine 101) and an electric motor (e.g., motor generator 106). Line 360 shows the engine torque alone, and line 362 plots a combination of the engine torque and electric motor torque. As such, area 364 illustrates the amount of torque provided by the electric motor over time. Line 370 shows an engine-out soot rate of the system from plot 300 (i.e., engine 101 providing all of the torque), while line 372 shows an engine-out soot rate for the system from plot 350 (i.e., engine 101 and motor generator 106 working together). As shown in plot 350, the overall soot rate is lower for the system from plot 350 in which the transient circuit 220 utilizes power from the motor generator 106 in order to assist with acceleration during transient operation.

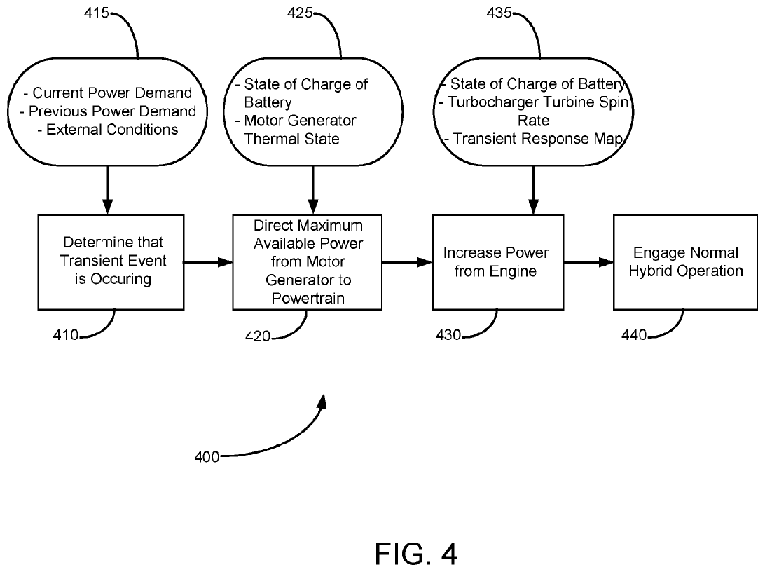

FIG. 4 is a flow diagram of a method 400 utilized by the controller and particularly the transient circuit, according to an example embodiment. Method 400 begins at process 410 where the transient circuit 220 determines that the vehicle 100 is experiencing a transient event. This determination is made based on data from process 415, which include a difference between a current power demand to a previous power demand. If the difference exceeds an adjustable threshold over a period of time, the transient circuit 220 determines that a transient event is occurring. This period of time may be pre-defined, based on external conditions, or set by user preference (e.g., more than five seconds and less than one minute, etc.). The method 400 proceeds to process 420, where the transient circuit 220 directs a maximum available amount of power from the motor generator 106. The maximum available amount of power is determined based on data from process 425, which include a SOC of the battery 107 and a thermal state of the motor generator 106. For example, a full SOC may correspond with the highest power output from the motor generator 106 for the longest period of time possible from the motor generator 106. In comparison, at fifty-percent SOC, the motor generator 106 may only be able to provide full power for fifty-percent as long (assuming a linear relationship). In other embodiments, a different amount of power from the motor generator 106 is commanded (e.g., less than full power). For example, the transient circuit may command the motor generator 106 to provide power equal or substantially equal to the power delta thereby avoiding the engine load transient. This may be appealing in a parallel hybrid vehicle. In operation, the transient circuit may store a power output-to-SOC (or another parameter(s)) map or table. Based on the determined power delta, the transient circuit looks up the power in the map or table and then commands this power from the motor generator to power the vehicle and substantially alleviates the engine load transient. In turn, this commanded amount may be less than the maximum available power output from the motor generator 106. The method 400 proceeds to process 430, where the transient circuit 220 gradually increases the power output from the engine 101. The amount of power output from the engine is determined based on data from process 435, which include a SOC of the battery, so that the powertrain system 110 can continue to meet the required power demand as available power from the motor generator 106 decreases, and a spin rate of the turbocharger 109 turbine. The spin rate of the turbocharger 109 turbine indicates a soot rate production from the engine 101, as a higher spin rate leads to increased air flow, which in turn reduces the amount of soot and unburnt HC in the exhaust flow. The data from process 435 may also include a transient response map that stores data on how the engine 101 has previously performed in transient events, thereby enabling the controller 140 to adjust the amount of power from the motor generator 106 in anticipation of predicted engine 101 performance. Based on these stored data, the transient circuit 220 can further improve the gradual increase of engine power. The method 400 ends at process 440, where the transient circuit 220 engages normal hybrid operation of the powertrain system 110 once the turbocharger is swirled up and/or the air/fuel ratio in the engine 101 is an acceptable level. Normal hybrid operation refers to a situation in which the power provided to the powertrain system 110 is balanced from the engine 101 and the motor generator 106.

The temperature management circuit 222 is configured or structured to improve warm-up and stay-warm processes for the aftertreatment system 120. Many components (particularly the SCR 123) must be at a certain operating temperature (e.g., 250-300° C. for the SCR 123 catalyst) in order to effectively reduce the pollutants (e.g., NOx) in the exhaust. As such, when the vehicle 100 is cold started (i.e., at ambient temperatures), the aftertreatment system 120 is likely below operating temperature and will not reduce the exhaust pollutants (e.g., NOx) as desired. Bringing the aftertreatment system up to the operating temperature (i.e., the warm-up process) is, therefore, an important procedure. However, traditional methods for thermal management, such as increasing the exhaust temperature by injecting extra fuel into the combustion chamber (i.e., in-cylinder), reduce the efficiency of in-cylinder combustion and may create additional soot, particulate matter, and/or NOx. Further, the exceptionally high exhaust gas temperatures caused by these traditional methods can cause long-term damage to aftertreatment system 120 components, and the higher levels of fueling in these traditional methods can lead to increased sulfur exposure on the SCR 123 catalyst, which degrades performance. The temperature management circuit 222 is configured to leverage the added utility of the motor generator 106 in the hybrid powertrain system 110 in order to warm the aftertreatment system 120 while reducing the amount of produced soot, particulate matter, or NOx. Put simply, the temperature management circuit 222 determines, based on a temperature of the aftertreatment system 120, whether to follow warm-up or stay-warm procedures, and then to take an associated thermal management action.

In one embodiment, the temperature management circuit 222 commands the engine 101 to operate at a higher load than would be otherwise requested (based on current driving conditions) and directs the increased power to re-charge the battery 107. By operating at a higher load, the engine 101 is generating exhaust at a higher temperature, which warms the aftertreatment system 120 more quickly, thereby bringing the aftertreatment system 120 to an operational temperature more quickly. Rather than directing the entirety of the power output from the engine 101 to the drivetrain, which would be unnecessary because the power request from the engine 101 is greater than the power required to operate the vehicle 100 in current conditions, the additional power (i.e., the portion of the power output from the engine 101 that is not required for vehicle 100 operation) is directed to the motor generator 106, which directs this additional power towards recharging the battery 107. As such, the additional power generated as a by-product of the temperature management circuit 222 commanding the engine 101 in order to generate hotter exhaust is directed to a productive use.

In a second embodiment, the temperature management circuit 222 initiates a generator mode when the vehicle would otherwise be in a vehicle stop operation (e.g., idling), such that the engine 101 continues to run while the vehicle 100 is stopped, expending additional power to the motor generator 106 that recharges the battery 107. By continuing to run during idle (e.g., at a higher than idle power output), the engine 101 produces warming exhaust gas during a period when the engine 101 would otherwise not, thereby warming the aftertreatment system 120 during a period when the aftertreatment system 120 would otherwise experience lower temperatures.

In a third embodiment, the temperature management circuit 222 prioritizes engine 101 operation over power output from the motor generator 106, thereby suppressing full electric vehicle operation (i.e., substantially all of the powertrain system 110 output coming from the motor generator). When in electric vehicle operation, little to no exhaust gas is generated, which means that no warming energy is being applied to the aftertreatment system 120. As such, during electric vehicle operation, the aftertreatment system 120 is susceptible to cool down. By periodically prioritizing engine 101 operation over electric vehicle operation, the temperature management circuit 222 avoids these cool downs. In each of these three embodiments, the temperature management circuit 222 is able to reduce soot buildup in the aftertreatment system 120, reduce the frequency of traditional engine 101 thermal management methods, and reduce the prevalence of active DPF 122 regeneration events.

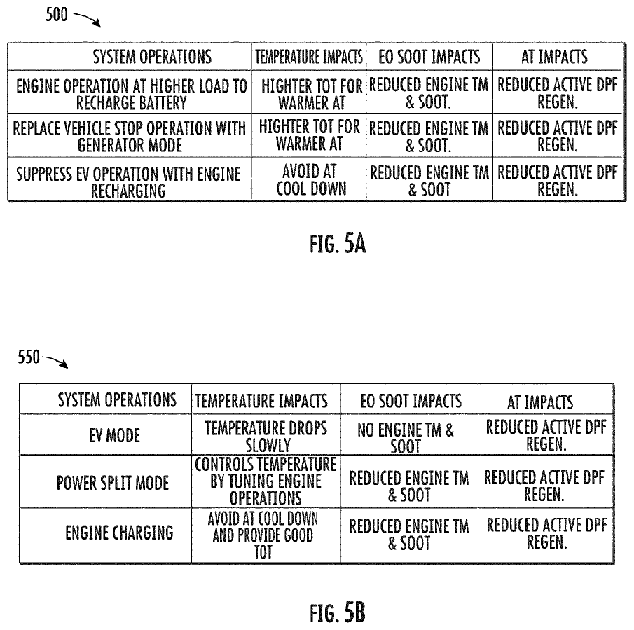

FIG. 5A is a table showing each of the three embodiments' impacts on the temperature of the exhaust gas in the aftertreatment system, on the amount of soot generation, and on the aftertreatment system 120 regeneration frequency. The first row, which corresponds to the first embodiment above, states that operating the engine 101 at a higher load increases a Turbocharger Out Temperature (TOT) of the exhaust gas (leading to a higher aftertreatment system 120 temperature), reduces soot generation from the engine 101 (which reduces an amount of subsequent thermal management by the engine 101), and reduces frequency of active DPF 122 regeneration. The second row, which corresponds to the second embodiment above, states that bypassing normal idle operation and directing the additional power output to the battery 107 increases a TOT of the exhaust gas (leading to a higher aftertreatment system 120 temperature), reduces soot generation from the engine 101 (which reduces an amount of subsequent thermal management by the engine 101), and reduces frequency of active DPF 122 regeneration. The third row, which corresponds to the third embodiment above, states that prioritizing engine 101 operation over motor generator 106 operation avoids possible cool down of aftertreatment system 120 temperatures, reduces soot generation from the engine 101 (which reduces an amount of subsequent thermal management by the engine 101), and reduces frequency of active DPF 122 regeneration.

The temperature management circuit 222 is also configured to assist in the maintenance of a desired operating temperature of the aftertreatment system 120 so that the aftertreatment system 120 can continue to operate effectively without having to engage traditional thermal management methods. In a first embodiment, the temperature management circuit 222 engages electric vehicle operation, in which substantially all of the power output from the powertrain system 110 is produced by the motor generator 106. When the engine 101 is off, no exhaust is being produced. Although this may result in a cool down of the aftertreatment system 120 due to no warming exhaust gas passing through the aftertreatment system 120, there is no soot, particulate matter, or NOx produced, which reduces the necessity of the aftertreatment system 120. In a second embodiment, the temperature management circuit 222 commands a power split mode in which power is produced by both the engine 101 and the motor generator 106. In this power split mode, the temperature management circuit 222 balances power production from the engine 101, which maintains a temperature of the aftertreatment system 120 but produces pollutants, with power production from the motor generator, which produces no pollutants but causes the aftertreatment system 120 to cool. In a third embodiment, the temperature management circuit 222 commands an engine charging mode in which the engine 101 is run at a higher load, with the excess power output from the engine 101 (i.e., all or a certain amount of power generated by the engine 101 that is not used by the powertrain system 110 to drive the vehicle 100 forward) directed to charge the battery 107. During engine charging mode, the increased power output from the engine 101 leads to increased exhaust temperature, which increases the aftertreatment system 120 temperature, without the excess pollutants of traditional warming methods. In each of these three embodiments, the temperature management circuit 222 reduces an amount of soot buildup in the aftertreatment system 120 (reducing soot buildup to zero in the first embodiment), reduces the frequency of traditional engine 101 thermal management methods (reducing the frequency to none in the first embodiment), and reduces the frequency of active DPF 122 regeneration events.

FIG. 5B is a table showing each of the three embodiments' impacts on the temperature of the exhaust gas in the aftertreatment system, on the amount of soot generation, and on the aftertreatment system 120 regeneration frequency. The first row, which corresponds to the first embodiment above, states that initiating an electric vehicle mode for the vehicle 100 causes the aftertreatment system 120 temperature to drop slowly, but generates no soot (thereby requiring no thermal management from the engine 101) and reduces the frequency of active DPF 122 regeneration. The second row, which corresponds to the second embodiment above, states that splitting the power generation for the powertrain system 110 between the engine 101 and the motor generator 106 allows for the aftertreatment system 120 temperature to be controlled, which reduces soot generation by the engine 101 (thereby reducing corresponding thermal management) and reduces the frequency of active DPF 122 regeneration. The third row, which corresponds to the third embodiment above, states that engaging engine 101 charging avoids cool down of aftertreatment system 120 temperatures by providing improved TOT exhaust gas temperatures, which reduces soot generation by the engine 101 (thereby reducing corresponding thermal management) and reduces the frequency of active DPF 122 regeneration.

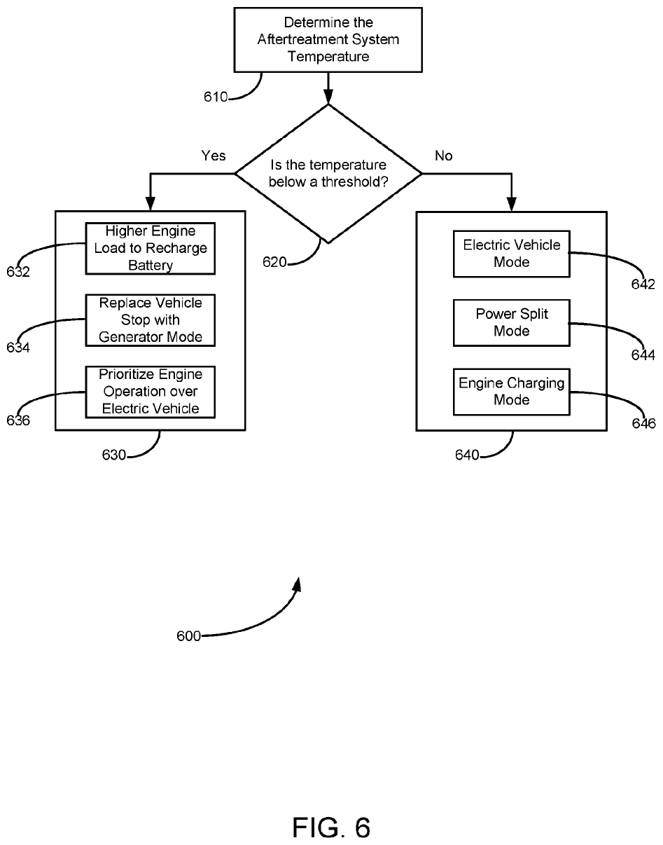

FIG. 6 is a flow diagram of a method 600 for managing a temperature of the aftertreatment system 120 utilized by the temperature management circuit 222 and the controller 140, according to an example embodiment. The method 600 begins at step 610, where the temperature management circuit 222 determines a temperature of the aftertreatment system 120. The temperature may be determined by the temperature sensor(s) 126. The temperature may be a temperature of a particular component of the aftertreatment system 120, an average temperature of a component of interest of the aftertreatment system, or as a temperature of the exhaust gas entering the aftertreatment system 120 (or at another location). The temperature management circuit 222 then compares the temperature to a threshold at 620. This threshold may be a predefined value of a desired operating temperature of the aftertreatment system 120, which is defined as a temperature at which the aftertreatment is operating to reduce harmful components to an acceptable level (e.g., based on regulations). Thus, the threshold may be specific to certain components or to the system as a whole. In one embodiment, the desired operating temperature is based on a NOx conversion efficiency. Accordingly, the operating temperature is a temperature at which the NOx conversion efficiency is at or above a certain value (e.g., 95%). In another embodiments, a different parameter may be used, such as soot opacity. If the aftertreatment system 120 temperature from process 610 is below the threshold, the method proceeds to process 630 (620: YES). At process 630, the temperature management circuit 222 goes to one or more of the thermal management actions from steps 632-636 based on the situation.

At process 632, the temperature management circuit 222 increases a load on the engine and diverts the extra power output to charging the battery 107. The method 600 proceeds to process 632 if the SOC of the battery 107 is low (i.e., below an SOC threshold) or if the current load on the engine 101 is low enough (i.e., the power demand on the powertrain system 110 is low enough) that the load can be increased without undue stress on the engine 101. Because process 632 involves increasing the load on the engine 101 in order to generate hotter exhaust gas, the method 600 checks the current load on the engine 101 in order to determine if it is possible to increase the engine 101 load without pushing the engine 101 beyond its limits. At process 634, the temperature management circuit 222 replaces a vehicle stop mode with a generator mode, such that the engine 101 continues to run when the vehicle 100 is stopped, with the power output from the engine 101 directed to charging the battery 107. The method proceeds to process 634 if the vehicle 100 is stopped. At process 636, the temperature management circuit 222 prioritizes operation of the engine 101 over electric vehicle operation (i.e., substantially all of the power output from the powertrain system 110 is generated by the motor generator 106). The method proceeds to process 636 if normal hybrid operation would otherwise dictate full electric vehicle operation.

If the aftertreatment system 120 (or a component thereof) from process 610 is not below the threshold, the method proceeds to process 640 (620: NO). At process 640, the temperature management circuit 222 goes to one or more of the thermal management actions from 642-646 based on the situation. At process 642, the temperature management circuit 222 engages full electric vehicle mode in order to reduce the amount of soot, particulate matter, and NOx generated. In this mode, the engine may be turned off in favor of the motor generator by the controller 140. The method 600 proceeds to process 642 if the power demand on the powertrain system 110 is low enough to be satisfied entirely by the motor generator and if the temperature of the aftertreatment system 120 is sufficiently high so as to remain above an operating temperature with the expected cool down that accompanies full electric vehicle operation. At process 644, the temperature management circuit 222 engages a power split mode, such that the temperature management circuit 222 balances supplying heat energy to the aftertreatment system 120 through exhaust from the engine 101 while also keeping NOx emissions low by utilizing the motor generator 106. As such, the distribution of power (i.e., an amount of power from the engine 101 and an amount of power from the motor generator 106) during the power split mode is based, in part, on an amount of engine-out NOx. At process 646, the temperature management circuit 222 increases a load on the engine 101 and diverts the additional power output to charge the battery 107. The method 600 proceeds to process 646 if the SOC of the battery 107 is low.

The regeneration circuit 224 is configured to facilitate passive regeneration of the DPF 122 in order maintain DPF 122 performance without the service interruptions or long-term hydrothermal degradation that accompany active regeneration events. Soot accumulation on the DPF 122 traditionally requires high-temperature (500-600° C.) active regeneration events, which causes hydrothermal degradation of catalysts (e.g., SCR 123 catalyst) in the aftertreatment system 120. However, DPF 122 performance can be passive regenerated by NO2 in the exhaust at lower temperatures (250-350° C.), but these temperatures are difficult to reach through normal operation for engines with a low load or that run efficiently. The high NOx:PM ratio at an inlet of the DPF that is required for passive regeneration in low temperatures presents its own difficulties, as the SCR 123 cannot convert enough NOx at those low temperatures in order to meet tailpipe-out NOx requirements in the high engine-out NOx mode used to reach the high NOx:PM ratio. The regeneration circuit 224 is configured to leverage the added utility of the motor generator 106 in the powertrain system 110 in order to improve the vehicle's passive regeneration ability.

In one embodiment, the regeneration circuit 224 increases the load on the engine 101 and directs the additional power output to charging the battery 107. By increasing the engine 101 load, the regeneration circuit 224 is increasing the exhaust temperature but doing so in a way that reducing waste by directing the extra power output to a productive use. However, this embodiment does produce increased engine-out NOx, but increases the passive regeneration for the DPF 122. In a second similar embodiment, the regeneration circuit 224 keeps the engine 101 operating during a vehicle 100 stop and directs that power output towards charging the battery. Similarly, operating the engine 101 here produces hot exhaust that maintains the desired aftertreatment system 120 temperature while productively charging the battery 107. However, much like the first embodiment, this second embodiment does produce increased engine-out NOx while also increasing the passive regeneration for the DPF 122.

In a third embodiment, the regeneration circuit 224 commands the heater 125 to activate and increase the exhaust gas temperature prior to the exhaust reaching the DOC 121, thereby improving regeneration without generating additional pollutants or particulate matter. In this embodiment, the regeneration circuit 224 maintains a temperature at the inlet of the DOC 121 (or DPF 122) via the heater 125 in order to maintain high levels of passive regeneration (i.e., a likelihood that a passive regeneration event occurs during operation of the vehicle that is considered “high” such as a greater than fifty-percent chance). In a fourth similar embodiment, the regeneration circuit 224 commands the heater 125 to activate and increase the exhaust gas temperature prior to the exhaust reaching the SCR123, thereby improving the NOx conversion capability of the SCR 123 catalyst, which indirectly improves passive regeneration by allowing the engine 101 to operate in a higher engine-out NOx mode without concerns over producing more NOx than the aftertreatment system 120 can effectively reduce. As such, in this fourth embodiment, the regeneration circuit 224 maintains a temperature at the inlet of the SCR 123 in order to increase a likelihood of a passive regeneration event for aftertreatment system 120 components.

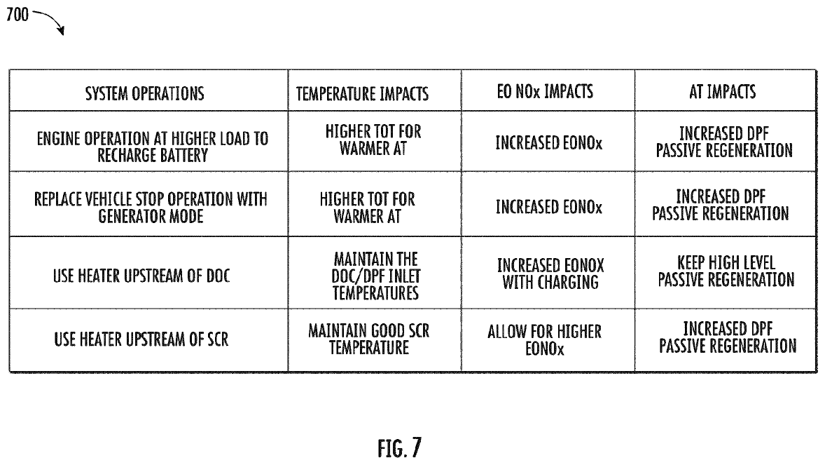

FIG. 7 is a table showing each of the four embodiments' impacts on the temperature of the exhaust gas in the aftertreatment system, on the amount of engine-out NOx (EONOx) generation, and on the aftertreatment system 120 component regeneration. The first row, which corresponds to the first embodiment above, states that operating the engine 101 at a higher load increases a TOT of the exhaust gas (which warms the aftertreatment system 120), increases an amount of EONOx, and increases an amount of DPF 122 passive regeneration. The second row, which corresponds to the second embodiment above, states that bypassing normal vehicle stop operation in order to run the engine 101 while the vehicle 101 is stationary increases a TOT of the exhaust gas (which warms the aftertreatment system 120), increases an amount of EONOx, and increases an amount of DPF 122 passive regeneration. The third row, which corresponds to the third embodiment above, states that engaging the heater 125 upstream of the DOC 121 maintains a temperature of the exhaust gas at an inlet of the DPF 122 or DOC 121 (depending on the arrangement of the aftertreatment system 120), allows for an increased amount of EONOx (because elevated aftertreatment system 120 temperatures can lead to increased NOx reduction efficiency), and maintains a high level of aftertreatment system 120 passive regeneration. The fourth row, which corresponds to the fourth embodiment above, states that engaging the heater 125 upstream of the SCR 123 maintains a temperature of the exhaust gas at an inlet of the SCR 123, allows for an increased amount of EONOx (because elevated SCR 123 temperatures can lead to increased NOx reduction efficiency by the SCR 123), and increases DPF 122 passive regeneration.

The idle circuit 226 is structured or configured to improve idle operation of the vehicle 100 in order to avoid the accumulation of water and HC in the aftertreatment system 120. When the vehicle 100 is stopped and the engine 101 is idling, the temperature of the exhaust gas leaving the engine 101 is likely low, which can cause the temperature of the aftertreatment system 120 or a component thereof to drop below a desired operating temperature (e.g., 100° C.) and fall out of an effective temperature range. Additionally, at these low temperatures, water and HC in the exhaust can condense and accumulate throughout the aftertreatment system 120, and the resultant moisture can degrade certain components. Further, these accumulations often “light-off” during the next temperature increase, which causes thermal damage to the aftertreatment system 120 or a component thereof. Traditionally, an idle speed (i.e., a speed of the engine 101 while idling) is increased in order to raise the exhaust temperature and combat the accumulation of water and HC, but these methods consume additional fuel. The idle circuit 226 is configured to leverage the additional utility of the motor generator 106 of the hybrid powertrain system 110 in order to improve idle operation without the additional and wasteful fuel use.

In one embodiment, the idle circuit 226 periodically increases the temperature of the aftertreatment system 120 in order to mitigate the risk of HC and water accumulation. In order to increase the aftertreatment system 120 temperature, the idle circuit 226 increases the load on the engine 101 and diverts the additional power output towards charging the battery 107. With an increased load, the engine 101 outputs exhaust gas at a higher temperature, which desorbs the accumulated water and HC. This process also productively charges the battery 107, which is an improvement over the wasteful fuel use of traditional methods. In another embodiment, the idle circuit 226 engages the heater 125 and a charging mode of the engine 101 (i.e., running the engine 101 at a higher load and diverting the additional power to the battery 107) in order to maintain aftertreatment system 120 temperatures above a value at which the water and HC accumulate, thereby pre-emptively preventing accumulation and catalyst degradation.

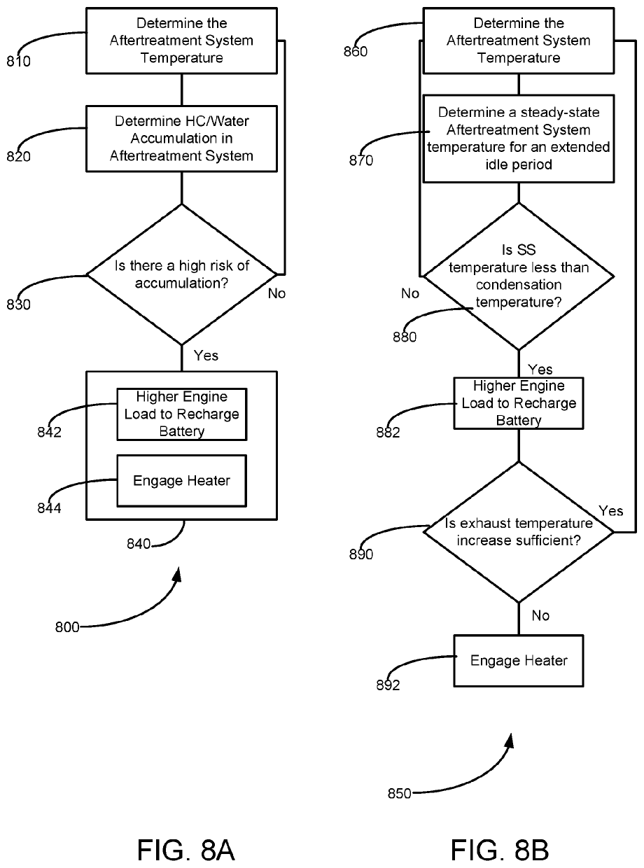

FIG. 8A is a flow chart of a first method 800 utilized by the idle circuit 226 and controller 140 to periodically increase the temperature of the aftertreatment system 120 in order to improve idle operation. The method 800 begins at step 810, where the idle circuit 226 determines a current temperature of the aftertreatment system 120. This may be based on output from the temperature sensor(s) 126 and given as a temperature of any one component of the aftertreatment system 120, an average temperature of the components of the aftertreatment system, or as a temperature of the exhaust gas entering the aftertreatment system 120. At 820, the idle circuit 226 determines that an amount of HC and/or water that has accumulated throughout the aftertreatment system 120 exceeds a predefined threshold. This determination may be made by the sensor array 129, or can be an estimation based on the aftertreatment system 120 temperature. For example, the determination may be a time-based calculation that assumes a fixed rate of accumulation based on the determined temperature. In another example, the determination may be made based on a sensed flow rate of exhaust through the aftertreatment system 120, as accumulation throughout the aftertreatment system 120 would negatively affect flow. As such, the predefined threshold may be an amount of accumulation in some embodiments and may be an exhaust flow rate in other embodiments. At 830, the idle circuit 226 determines whether there is a risk of additional accumulation. This determination may be made by comparing the determination at 820 to a threshold. If the determination at 830 exceeds the threshold, possibly due to the vehicle 100 idling for an extended period of time or to the aftertreatment system 120 temperature being especially low, then the idle circuit 226 determines that there is a heightened risk of HC and/or water accumulation and the method 800 proceeds to 840 (830 YES). At 840, the idle circuit 226 performs one or both of steps 842 and 844 based on the situation. At 842, the idle circuit 226 increases a load on the engine 101 and directs the additional power output towards charging the battery 107 via the motor generator 106. By increasing the engine 101 load, the idle circuit 226 increases the exhaust temperature (due to the engine 101 operating at a higher temperature in order to meet the power demand for the increased load), thereby desorbing the accumulated water and HC. At 844, the idle circuit 226 engages the heater 125, which warms the exhaust gas flow and similarly desorbed any accumulated water and HC.

FIG. 8B is a flow chart of a second method 850 utilized by the idle circuit 226 to maintain the temperature of the aftertreatment system 120 above a threshold in order to improve idle operation. The method 850 begins at step 860, where the idle circuit 226 determines the aftertreatment system 120 temperature. This may be based on output from the temperature sensor(s) 126 and given as a temperature of any one component of the aftertreatment system 120, an average temperature of the components of the aftertreatment system, or as a temperature of the exhaust gas entering the aftertreatment system 120. At process 870, the idle circuit 226 determines a steady-state value for the aftertreatment system 120 temperature. In some embodiments, this steady-state value may be a temperature of a component that is within a predefined range for a predefined period of time. In other embodiments, the steady-state value is a reading from the temperature sensor 126 that is substantially constant (i.e., within a predefined range) for a predefined period of time. In further embodiments, the steady-state value is based on multiple readings from one or more temperature sensor(s) 126 in the aftertreatment system 120 that are substantially constant (i.e., within a predefined range) for a predefined period of time. At 880, the idle circuit 226 determines whether the determined steady-state value from 870 is less than a temperature at which the HC and water begin to accumulate (i.e., a condensation temperature threshold). If the steady-state temperature is greater than or equal to the condensation temperature threshold, the method returns to step 860 (880:NO). If the steady-state temperature is less than the condensation temperature threshold, the method proceeds to 882 (880:YES). At 882, the idle circuit 226 increases a load on the engine 101 and directs the additional power output towards charging the battery. By increasing the engine 101 load, the idle circuit 226 increases the exhaust temperature and, subsequently, the steady-state aftertreatment system 120 temperature (e.g., of the system as a whole or a component thereof). At 890, the idle circuit 226 determines if the increased engine 101 load at 882 was sufficient to raise the steady-state aftertreatment system 120 temperature above the condensation temperature threshold. If the increased engine 101 load was sufficient, the method returns to 860 to repeat the method 800 (890:YES). If the increased engine 101 load was insufficient and the steady-state aftertreatment system 120 temperature remains below the condensation temperature threshold, the idle circuit 226 engages the heater 125 in order to further raise the temperature of the exhaust.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using one or more separate intervening members, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

While various circuits with particular functionality are shown in FIGS. 2-6B, it should be understood that the controller 140 may include any number of circuits for completing the functions described herein. For example, the activities and functionalities of the transient circuit 220, the temperature management circuit 222, the regeneration circuit 224, and the idle circuit 226 may be combined in multiple circuits or as a single circuit. Additional circuits with additional functionality may also be included. Further, the controller 140 may further control other activity beyond the scope of the present disclosure.

As mentioned above and in one configuration, the “circuits” may be implemented in machine-readable medium for execution by various types of processors, such as the processor 204 of FIG. 2. Executable code may, for instance, comprise one or more physical or logical blocks of computer instructions, which may, for instance, be organized as an object, procedure, or function. Nevertheless, the executables need not be physically located together, but may comprise disparate instructions stored in different locations which, when joined logically together, comprise the circuit and achieve the stated purpose for the circuit. Indeed, a circuit of computer readable program code may be a single instruction, or many instructions, and may even be distributed over several different code segments, among different programs, and across several memory devices. Similarly, operational data may be identified and illustrated herein within circuits, and may be embodied in any suitable form and organized within any suitable type of data structure. The operational data may be collected as a single data set, or may be distributed over different locations including over different storage devices, and may exist, at least partially, merely as electronic signals on a system or network.

While the term “processor” is briefly defined above, the term “processor” and “processing circuit” are meant to be broadly interpreted. In this regard and as mentioned above, the “processor” may be implemented as one or more processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

What is claimed is:

1. A method, comprising:
determining, by a controller, that a transient event for a hybrid vehicle is occurring;
determining, by the controller, an increase of power demand for the hybrid vehicle based on the determined transient event;
directing, by the controller, an amount of power from an electric motor of the hybrid vehicle to a powertrain of the hybrid vehicle based on the increase in power demand, the amount of power from the electric motor determined based on a state of charge of a battery of the hybrid vehicle; and
increasing, by the controller, an amount of power from an engine of the hybrid vehicle as a power output from the electric motor decays to avoid an engine power output spike from the engine based on the determined increase in power demand.

2. The method of claim 1, wherein the increase of the amount of power from the engine is based on at least one of the state of charge of the battery or a spin rate of a turbine of a turbocharger of the hybrid vehicle.

3. The method of claim 1, further comprising initiating, by the controller, normal hybrid operation for the hybrid vehicle.

4. The method of claim 3, wherein initiating normal hybrid operation is based on a determination that a spin rate of a turbine of a turbocharger of the hybrid vehicle is at an operational threshold and/or that an air-to-fuel ratio of the engine is at a predefined value.

5. The method of claim 1, wherein determining that the transient event for the hybrid vehicle is occurring comprises:
determining, by the controller, a previous power demand of the hybrid vehicle;
determining, by the controller, a current power demand of the hybrid vehicle;
determining, by the controller, a power demand difference between the current power demand of the hybrid vehicle and the previous power demand of the hybrid vehicle; and
determining, by the controller, that the transient event is occurring based on the power demand difference being above a threshold for a period of time.

7. A method for managing a temperature of an aftertreatment system in a hybrid vehicle, the method comprising:
determining, by a controller, the temperature of the aftertreatment system;
comparing, by the controller, the temperature of the aftertreatment system to a threshold; and
responsive to the comparison, causing, by the controller, a thermal management action for the aftertreatment system, the thermal management action including at least one of:
directing, by the controller, an engine of the hybrid vehicle to operate at a relatively higher load than a present engine load; or
bypassing a turn off event for the engine so the engine runs during a vehicle stop period.

8. The method of claim 7, wherein the thermal management action further includes reducing, by the controller, an amount of energy from an electric motor of the hybrid vehicle to a powertrain of the hybrid vehicle.

9. The method of claim 7, wherein in response to the temperature of the aftertreatment system being at or above the threshold, the thermal management action comprises one of:
engaging, by the controller, an electric vehicle mode for the hybrid vehicle such that power for the hybrid vehicle is solely provided by an electric motor of the hybrid vehicle; or
directing, by the controller, a first amount of power from the electric motor of the hybrid vehicle and a second amount of power from the engine to a powertrain of the hybrid vehicle, wherein the first amount and the second amount are determined by the controller based an amount of engine out NOx.

10. The method of claim 7, further comprising:
determining, by the controller, at least one of an amount of hydrocarbon or water accumulation in the aftertreatment system, the amount of accumulation based on the temperature of the aftertreatment system;
responsive to the amount of accumulation exceeding a predefined amount, performing, by the controller, at least one of:
directing an engine of the hybrid vehicle to operate at a higher load by charging a generator or battery of the hybrid vehicle; or
activating a heater in the aftertreatment system.

11. The method of claim 10, wherein the temperature of the aftertreatment system is a steady-state temperature, and wherein the method further comprises:
determining, by the controller, that the steady-state temperature is less than a condensation temperature threshold;
responsive to the determination that the steady-state temperature is less than the condensation temperature threshold, directing, by the controller, the engine of the hybrid vehicle to operate at the higher load;
determining, by the controller, a temperature of the aftertreatment system following the operation of the engine at the higher load; and
responsive to a determination that the temperature of the aftertreatment system following the operation of the engine at the higher load is less than the condensation temperature threshold, activating, by the controller, the heater in the aftertreatment system.

12. The method of claim 11, wherein the heater is positioned upstream of a Diesel Oxidation Catalyst (DOC) or upstream of a Selective Catalytic Reduction (SCR) system.

13. The method of claim 7, further comprising:
determining, by the controller, that the temperature of the aftertreatment system is below a threshold temperature for a passive regeneration event; and
responsive to the determination, performing, by the controller, at least one of:
directing the engine of the hybrid vehicle to operate at a higher load by charging a generator or battery of the hybrid vehicle;
directing the engine to continue to run during a vehicle stop period; or
activating the heater in the aftertreatment system.

14. A system, comprising:
a controller for a hybrid vehicle, the controller comprising a processing circuit including at least one processor coupled to at least one memory storing instructions that, when executed by the at least one processor, cause the controller to:
determine that a transient event for the hybrid vehicle is occurring;
determine an increase of power demand for the hybrid vehicle based on the determined transient event;
direct an amount of power from an electric motor of the hybrid vehicle to a powertrain of the hybrid vehicle based on the increase in power demand, the amount of power from the electric motor determined based on a state of charge of a battery of the hybrid vehicle; and
increase an amount of power from an engine of the hybrid vehicle as a power output from the electric motor decays.

15. The system of claim 14, wherein the increase of the amount of power from the engine is based on at least one of the state of charge of the battery or a spin rate of a turbine of a turbocharger of the hybrid vehicle.

16. The system of claim 14, further comprising an exhaust aftertreatment system coupled to the controller, wherein the instructions, when executed by the at least one processor, further cause the controller to receive information regarding the exhaust aftertreatment system.

17. The system of claim 16, wherein the instructions, when executed by the at least one processor, further cause the controller to:
determine a temperature of the exhaust aftertreatment system;
compare the temperature of the exhaust aftertreatment system to a threshold; and
responsive to the comparison, cause a thermal management action for the exhaust aftertreatment system, the thermal management action including at least one of:
directing the engine of the hybrid vehicle to operate at a relatively higher load than a present engine load; or
bypassing a turn off event for the engine so the engine runs during a vehicle stop period.

18. The system of claim 17, wherein the thermal management action further includes reducing an amount of energy from the electric motor of the hybrid vehicle to a powertrain of the hybrid vehicle.

19. The system of claim 16, wherein the instructions, when executed by the at least one processor, further cause the controller to:
determine that a temperature of the exhaust aftertreatment system is below a threshold temperature for a passive regeneration event; and
responsive to the determination, perform at least one of:
directing the engine of the hybrid vehicle to operate at a higher load by charging a generator or battery of the hybrid vehicle;
directing the engine to continue to run during a vehicle stop period; or
activating a heater in the exhaust aftertreatment system.

20. The system of claim 16, wherein the instructions, when executed by the at least one processor, further cause the controller to:
determine at least one of an amount of hydrocarbon or water accumulation in the exhaust aftertreatment system, the amount of accumulation based on a temperature of the exhaust aftertreatment system;
responsive to the amount of accumulation exceeding a predefined amount, perform at least one of:
directing the engine of the hybrid vehicle to operate at a higher load by charging a generator or battery of the hybrid vehicle; or
activating a heater in the exhaust aftertreatment system.
